(19) United States
(12) Patent Application Publication
(10) Pub. No.: US 2020/0403343 A1
(43) Pub. Date: Dec. 24, 2020

(54) ELECTRICAL CONNECTOR WITH FLOATING CONTACT ELEMENT

(71) Applicant: METHODE ELECTRONICS, INC., Chicago, IL (US)

(72) Inventors: Chip Bronk, San Jose, CA (US); Hannah Han, Fremont, CA (US); Robert Keller, Rolling Meadows, IL (US); Michael Stibgen, Rolling Meadows, IL (US)

(21) Appl. No.: 16/829,747

(22) Filed: Mar. 25, 2020

Related U.S. Application Data
(60) Provisional application No. 62/823,257, filed on Mar. 25, 2019.
(60) Provisional application No. 62/916,857, filed on Oct. 18, 2019.

(51) Int. Cl. H01R 13/20; H01R 13/24; H01R 13/631

(52) U.S. Cl. CPC H01R 13/20; H01R 13/6315; H01R 13/2407

(57) ABSTRACT

An electrical connector socket includes an outer receptacle and an inner receptacle disposed with the outer receptacle. A biasing element disposed between the inner receptacle and the outer receptacle biases the inner receptacle to a predetermined position with respect to the outer receptacle and allows displacement of the inner receptacle from the predetermined position to another position in response to an external force.

### CROSS-REFERENCE TO RELATED APPLICATIONS

This application claims benefit under 35 U.S.C § 119 of U.S. Provisional Patent Application No. 62/823,257, filed on Mar. 25, 2019, and U.S. Provisional Patent Application No. 62/916,857, filed on Oct. 18, 2019, and it incorporates by reference the disclosures thereof in their entireties.

In addition, the subject matter of the following applications is incorporated herein by reference in its entirety: U.S. Utility application Ser. No. 16/829,672 filed Mar. 25, 2020, and entitled ELECTRICAL CONNECTOR WITH FLOATING CONTACT ELEMENT (B&T Ref. No. 49072-318243); U.S. Utility application Ser. No. 16/829,921, filed Mar. 25, 2020, and entitled ELECTRICAL CONNECTOR WITH FLOATING CONTACT ELEMENT (B&T Ref. No. 49072-318080); and U.S. Utility application Ser. No. 16/829,877, filed Mar. 25, 2020, and entitled ELECTRICAL CONNECTOR WITH FLOATING CONTACT ELEMENT (B&T Ref. No. 49072-318287).

### BACKGROUND OF THE DISCLOSURE

An electrical equipment cabinet may include a bus bar bearing a number of electrical connector sockets received in corresponding holes in the bus bar. A piece of electrical equipment may include mating electrical connector pins configured for insertion into the connector sockets borne by the bus bar.

Failure to precisely locate the connector sockets with respect to the bus bar and/or the connector pins with respect to the electrical equipment, for example, due to manufacturing tolerances, can result in misalignment of the sockets and pins. Such misalignment can inhibit or adversely affect the quality of the electrical connection between corresponding sockets and pins.

### BRIEF DESCRIPTION OF THE DRAWINGS

FIG. 1 illustrates a bus bar defining four apertures and four electrical connector sockets disposed in the apertures;

FIG. 2 is a side cross sectional-view of an illustrative electrical contact element;

FIG. 3 is a top plan view of the contact element of FIG. 2;

FIG. 4 is a side elevation view of the contact element of FIGS. 2 and 3 having an alternative housing profile;

FIG. 5A is a cut-away perspective view of a first illustrative embodiment of an electrical connector and a mating electrical connector received therein according to the present disclosure;

FIG. 5B is an exploded cut-away perspective view of the electrical connector of FIG. 5A;

FIG. 5C is a detail perspective view of a biasing element of the electrical connector of FIG. 5A;

FIG. 6A is a cut-away perspective view of a second illustrative embodiment of an electrical connector and a mating electrical connector received therein according to the present disclosure;

FIG. 6B is an exploded cut-away perspective view of the electrical connector of FIG. 6A;

FIG. 6C is a detail perspective view of a biasing element of the electrical connector of FIG. 6A;

FIG. 7A is a transparent view of a third illustrative embodiment of an electrical connector according to the present disclosure;

FIG. 7B is a cutaway view of the electrical connector of FIG. 7B;

FIG. 8A is a perspective view of a fourth illustrative embodiment of an electrical connector according to the present disclosure;

FIG. 8B is a transparent view of the electrical connector of FIG. 8A;

FIG. 8C is a cutaway view of the electrical connector of FIG. 8A;

FIG. 9 is a cutaway view of another illustrative embodiment of an electrical connector according to the present disclosure receiving a misaligned mating connector;

FIG. 10A is a side elevation view of an electrical connector element and a mating connector according to the present disclosure; and

FIG. 10B is a cutaway side elevation view of contact elements of the electrical connector element and the mating connector of FIG. 10A.

### DETAILED DESCRIPTION OF THE DRAWINGS

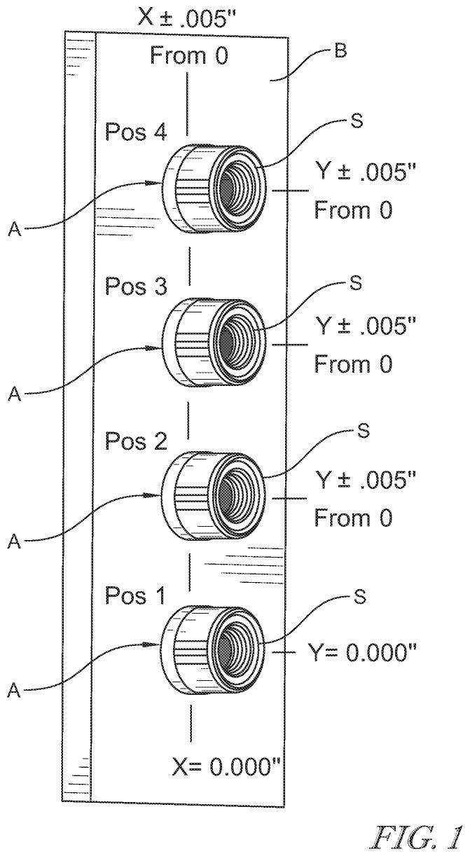

FIG. 1 shows an illustrative bus bar B as might be found in an electrical equipment cabinet (not shown). The bus bar B defines four apertures A arranged linearly proximate four corresponding, predetermined aperture locations. FIG. 1 also illustrates four electrical connector sockets S, each disposed within a corresponding one of the apertures A. Each of the electrical connector sockets S defines a cylindrical bore configured to receive a pin of a mating electrical connector (not shown in FIG. 1). The electrical connector sockets S are design so that the bores defined thereby are concentric with bodies thereof and concentric with the apertures A. As suggested by FIG. 1, the actual locations of the apertures A mighty vary somewhat from the predetermined aperture locations due to manufacturing tolerances. Similarly, the bores defined by the electrical connector sockets S might not be concentric with the bodies thereof due to manufacturing tolerances. FIG. 1 shows a non-limiting example of such deviation of aperture and bore locations from the respective design locations,

The predetermined aperture locations may correspond to predetermined locations of corresponding, mating electrical connector pins extending from a piece of electrical equipment (not shown) that may be removably received within the cabinet (not shown). The piece of electrical equipment may be, for example, an electrical equipment drawer removably receivable within the cabinet, or a piece of electrical equipment mounted on such a drawer. The actual locations of the pins (not shown) may vary somewhat from the respective predetermined aperture locations due to manufacturing tolerances.

The foregoing deviations of the aperture and pin locations from the respective predetermined locations, as well as manufacturing variations in the sockets S and the pins (not shown) themselves, can yield misalignment of respective sockets and pins. At worst, the misalignment may preclude insertion of the pins into the respective sockets. In less severe cases, the misalignment may adversely affect the quality of the electrical connection between the respective pins and sockets.

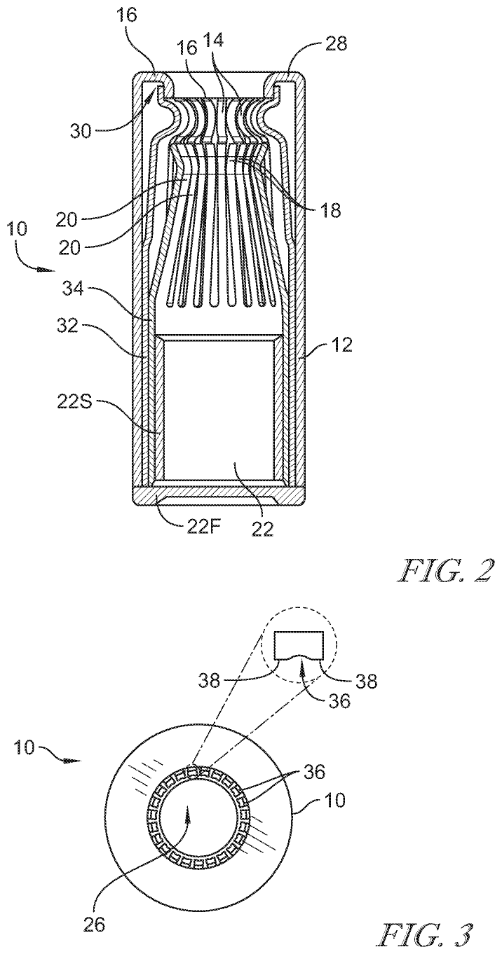

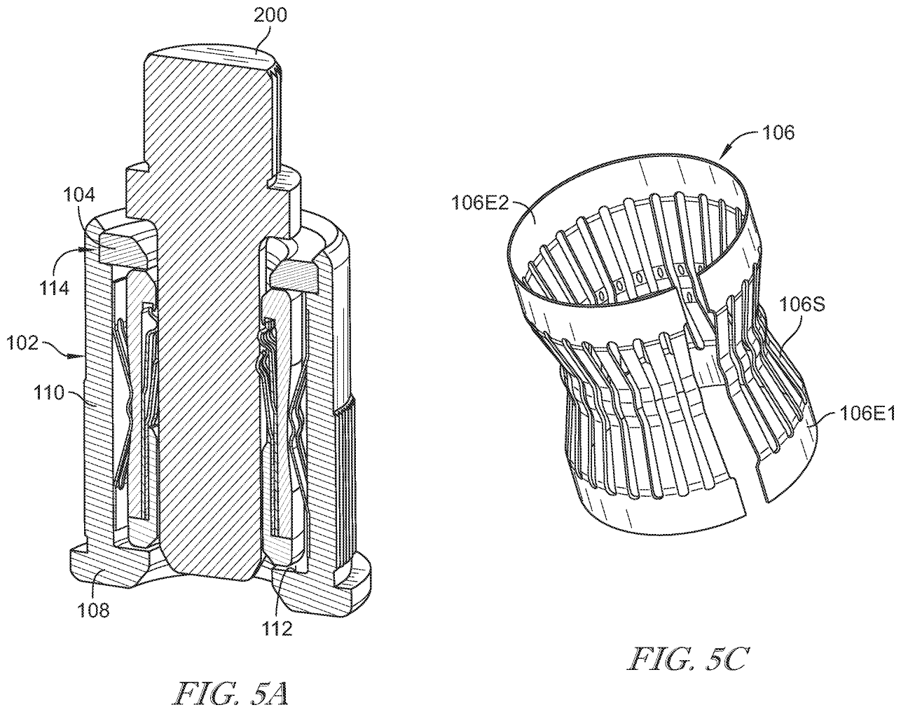

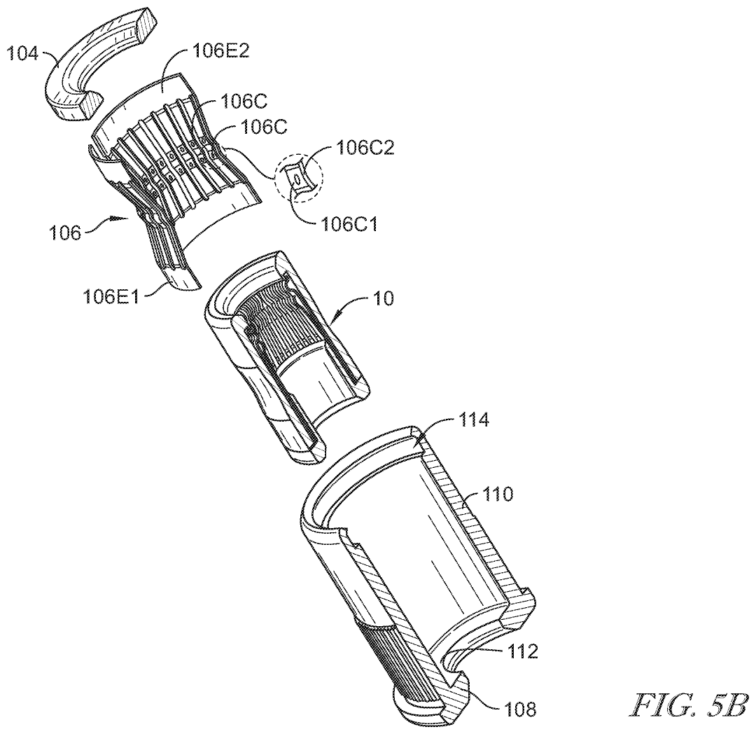

FIGS. 2 and 3 show an illustrative electrical contact element 10 including a generally cylindrical housing 12, a first generally cylindrical array 14 of flexible beams 16 received concentrically within the housing 12, a second generally cylindrical array 18 of flexible beams 20 received concentrically within the first array 14 of flexible beams 16, and a ferrule 22 having a generally cylindrical shaft 22S received concentrically within the second array 18 of flexible beams 29. The ferrule 22 also has a flange 22F from which the shaft 22S extends, the flange generally abutting an end of the housing 12. Individually and collectively, the housing 12, the first array 14, the second array 18, and the ferrule 22 define a cavity 24 configured to separably receive a mating connector, for example without limitation, the mating connector 200 shown in FIG. 5A.

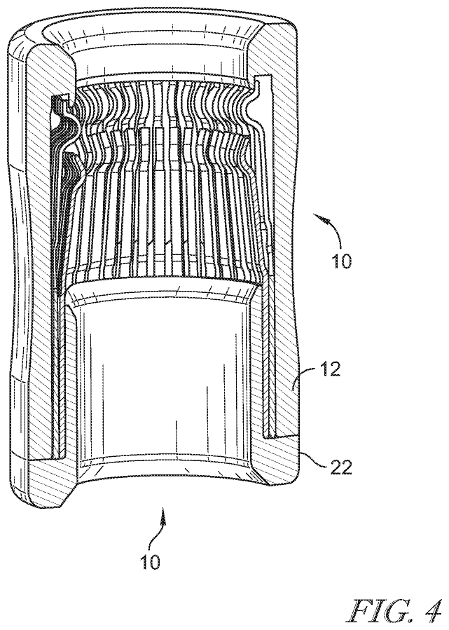

The housing 12 is shown as an annular sidewall having a first end and a second end. The sidewall of the housing 12 has an outer diameter and an inner diameter. A hood 28 extends radially inwardly from the second end of the housing 12 and then turns toward the first end of the housing 12, thereby defining an annular channel or slot 30 between the sidewall of the housing 12 and the free end of the hood 28. As shown in FIG. 2, the housing 12 may be right annular. As shown in FIG. 4, the housing 12 may be generally right annular with a circumferential concavity 36 between the first and second ends thereof.

The first array 14 of flexible beams 16 is shown as extending from a generally cylindrical base 32 abutting the housing 12 proximate the first end thereof. The first array 14 of beams 16 extends axially from the base 32 and radially inwardly toward the center of the cylinder defined by the first array 14 of flexible beams 15. Similarly, the second array 18 of flexible beams 20 is shown as extending from a generally cylindrical base 34 abutting the base 32 of the first array 14 of flexible beams 16 proximate the first end thereof. The first array 18 of flexible beams 20 extends axially from the base 34 and radially inwardly toward the center of the cylinder defined by the second array 18 of flexible beams 20. In an embodiment, the second array 18 of flexible beams 20 may be omitted. In other embodiments, other electrical contact arrangements defining a cylindrical cavity could be provided in lieu of either or both of the arrays 14, 18 of flexible beams 16, 20.

As suggested above, the ferrule 22 includes a generally circular flange 22F defining an aperture therethrough, and a generally annular shaft 22S defining a bore extending therethrough. The shaft 22S is connected to the flange 22F so that bore of the shaft 22S is generally concentric with the aperture of the flange 22F. The flange 22F has an second outer diameter about equal to the outer diameter of the housing 12.

All of the foregoing components of the contact element 10 are electrically conductive, and they are electrically coupled to each other. The inner diameter of the housing 12, the outer diameter of the shaft 22S, and the diameters of the bases 32, 34 of the first and second arrays 14, 18 of flexible beams 16, 20 are selected so that the bases 32, 34 are compressed against each other and between the housing 12 and the ferrule 22 when the housing 12, the first and second bases 32, 34, and the ferrule 22 are assembled as shown and as described above.

As best shown in FIG. 3, the distal portion of each of the flexible beams 16, 20 extending from the respective base 32, 34 defines a contact area 36 configured to engage the mating connector 200 in electrical contact therewith. In some embodiments, the contact area 36 may be formed to define two contact points or surfaces 38. In other embodiments, the contact areas 36 may be formed to define more or fewer than two contact points or surfaces 38. As best shown in FIG. 2, the distal end of each beam of the first array 14 of flexible beams 16 may be radially captured within the slot 30 defined by the sidewall of the housing 12 and the free end of the hood 28.

As suggested above, the contact element 10 may be configured to receive therein a pin of a mating connector element 200 in electrical engagement, so that low force is required to assemble the mating connector element to, and to disassemble the mating connector element from, the contact element 10. A non-limiting example of such a mating connector element 200 is shown in FIG. 5A.

FIGS. 5A-5C show a first illustrative embodiment of an electrical connector 100 according to the present disclosure. The connector 100 includes the contact element 10, a generally circular/cylindrical mounting base 102 configured to receive the contact element 10, a retainer 104 configured to capture the contact element 10 to the base 102, and a biasing element 106 disposed between the contact element 10 and the base 102. The biasing element 106 biases the contact element 10 radially with respect to the base.

More specifically, the base 102 includes a generally circular flange 108 that may define an aperture therethrough. A generally cylindrical sidewall 110 defining a bore therethrough extends axially from the flange 108, with the bore of the sidewall 110 generally concentric with the aperture of the flange 108. The bore defined by the sidewall 110 has an inner diameter substantially greater than the outer diameter of the flange 22F of the ferrule 22, thereby allowing substantial lateral (or radial) displacement of the contact element 10 with respect to the sidewall 110 when the contact element 10 is assembled to the base 102 as shown and as will be discussed further below. Also, the flange 108 and the sidewall 110 cooperate to define a land 112 within the sidewall 110. The land 112 is configured to abut a lower surface 40 of the flange 22F of the ferrule 22 and to support the flange 22F in engagement therewith when the contact element 10 is assembled to the base 102 as shown and as will be discussed further below. The inner surface of the sidewall 110 may define a circumferential groove 114 configured to receive an outer edge of the retainer 104. The outer surface of the sidewall 110 may be knurled.

The retainer 104 is shown as a retaining ring defining an aperture therethrough. The aperture of the retainer 104 has an inner diameter sufficiently lesser than the outer diameter of the housing 12 of the contact element 10 so that the retainer 104 captures the housing 12 of the contact element 10 to the base 102 when the retainer 104 is assembled to the base 102. Also, the inner diameter of the retainer 104 is sufficiently greater than the outer diameter of the pin of the mating connector element 200, thereby allowing substantial lateral (or radial) displacement of the pin with respect to the retainer 104 when the pin is inserted into the contact element 10.

The biasing element 106 is interposed between the contact element 10 and the base 102. As shown, the biasing element 106 is electrically coupled to both the contact element 10 and the base 102. The biasing element 106 biases the contact element 10 to a neutral position with respect to the base 102. The contact element 10 may be, but need not be, concentric with the base 102 in the neutral position. The contact element 10 may be displaced laterally with respect to the base 102 in response to a lateral force applied to the contact element 10 with respect to the base 102. Upon removal of the displacing force, the biasing element 106 may return the contact element 10 to the neutral position with respect to the base 102 without application of a further displacing force.

The biasing element 106 includes first and second axially opposed and annular end portions 106E1, 106E2 and an an annular array of spring members 106S extending between the first end portion 106E1 and the second end portion 106E2. Each of the spring members 106S is configured with one or more electrical contact areas 106C defined by an inner surface thereof. The electrical contact areas 106C are configured to make electrical contact with the contact element 10. Each of the end portions 106E1, 106E2 is configured to make electrical contact with the base 102.

FIGS. 5B and 5C show the spring members 106S as bent inwardly from each end 106E1, 106E2 of the biasing element 106 and then outwardly proximate the midpoint between the ends 106E1, 106E2. As such, each of the spring members 106S defines a pair of contact areas 106C on its inner surface. At least some of these contact areas 106C may remain in electrical contact with the contact element 10 regardless of the configuration of the contact element 10 with respect to the base 102. In some embodiments, all of these contact areas 106C remain in electrical contact with the base 102 regardless of the configuration of the contact element 10 with respect to the base 102. As best shown in FIG. 5B, each of the contact areas 106C may define two contact surfaces 106C1, 106C2 to thereby increase the number electrical contact points and/or the overall electrical contact area between the biasing element 106 and the contact element 10.

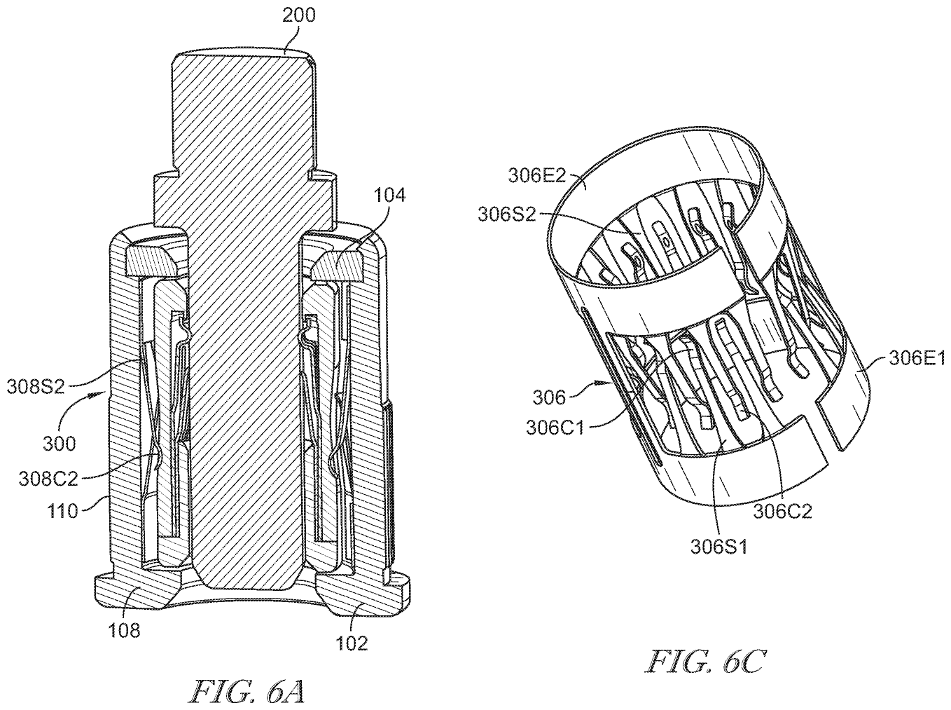

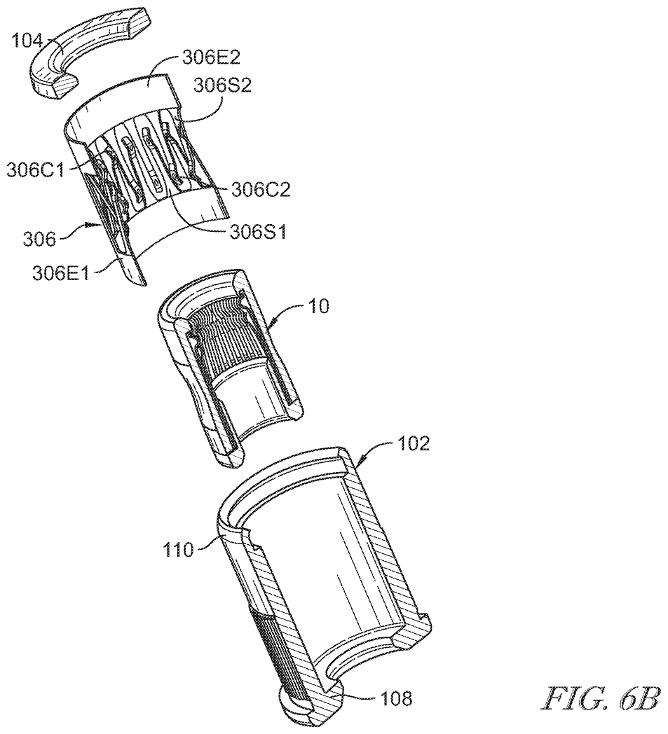

FIGS. 6A-6C show an illustrative second embodiment of an electrical connector 300 according to the present disclosure. The electrical connector 300 is similar to the electrical connector 100, except that it includes an alternative biasing element 306 instead of the biasing element 106 of the electrical connector 100. As such, the description of the electrical connector 300 herein will be limited to a description of the alternative biasing element 306.

The biasing element 306 includes first and second annular and axially opposed end portions 306E1, 306E2, a first annular array of spring members 306S1 extending from the first end portion 306E1 toward the second end portion 306E2, and a second annular array of spring members 306S2 extending from the second end portion 306E2 toward the first end portion 306E1. Each of the spring members 306S1, 306S2 is configured with one or more electrical contact areas 306C defined by an inner surface thereof. The electrical contact areas 306C are configured to make electrical contact with the contact element 10. Each of the end portions 306E1, 306E2 is configured to make electrical contact with the base 102. In the embodiment shown, each of the spring members 306S1, 306S2 is configured with first and second electrical contact areas 306C1, 306C2 defined by an inner surface thereof. The first and second electrical contact areas 306C1, 306C2 are similar to the first and second electrical contact areas 106C1, 106C2 of the electrical connector 100.

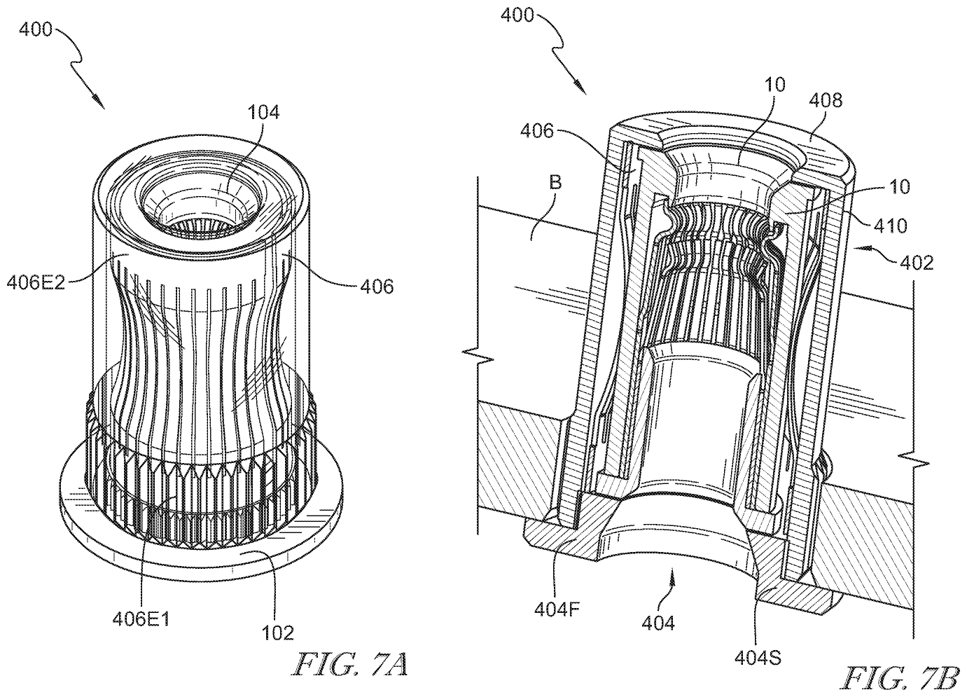

FIGS. 7A-7B show an illustrative third embodiment of an electrical connector 400 according to the present disclosure. The electrical connector 400 is similar to the electrical connector 100, except that it includes an alternative biasing element 406 instead of the biasing element 106 of the electrical connector 100 and an alternative base and retainer configuration. As such, the description of the electrical connector 400 herein will be limited to a description of the alternative biasing element 406 and the alternative base and retainer configuration.

The base 402 is inverted with respect to the base 102, such that the base 402 includes an annular flange 408 extending inwardly from an annular sidewall 410. Also, the base 402 is configured to receive a retainer 404 at an end thereof opposite the annular flange 408. In the embodiment shown, the retainer 404 is in the form of a ferrule similar to the ferrule 22 of the electrical connector 100, having a shaft portion 404S engaging with the sidewall 410 of the base 402 and a flange portion 404A engaging with the free end of the base 402.

The biasing element 406 includes first and second annular and axially opposed end portions 406E1, 406E2 and an annular array of spring members 406S extending between the first end portion 406E1 and the second end portion 406E2. Each of the spring members 406S is curved inwardly from the end portions 406E1, 406E2, towards the axial centerline of the biasing element 406. As such, the biasing element 408 has an hourglass-like shape.

Each of the spring members 406S may be configured with one or more electrical contact areas 406C defined by an inner surface thereof. The contact areas 406C may be, but need not be, similar to the contact areas 106C of the first connector 100. The electrical contact areas 406C are configured to make electrical contact with the contact element 10. In some embodiments, each of the spring members 406 is configured with first and second electrical contact areas similar to the first and second electrical contact areas 106C1, 106C2 of the electrical connector 100. Each of the end portions 406E1, 406E2 is configured to make electrical contact with the base 102.

The biasing element 406 is configured so that the contact areas 406C of at least some of the spring members 406S remain in electrical contact with the contact element 10 regardless of the configuration of the contact element 10 with respect to the base 108. In an embodiment, the contact areas 406C of all of the spring members 406S remain in electrical contact with the regardless of the configuration of the contact element 10 with respect to the base 102. In an embodiment, the end portions 406E of the biasing element 406E remain in electrical contact with the contact element 10 regardless of the configuration of the contact element 10 with respect to the base 102.

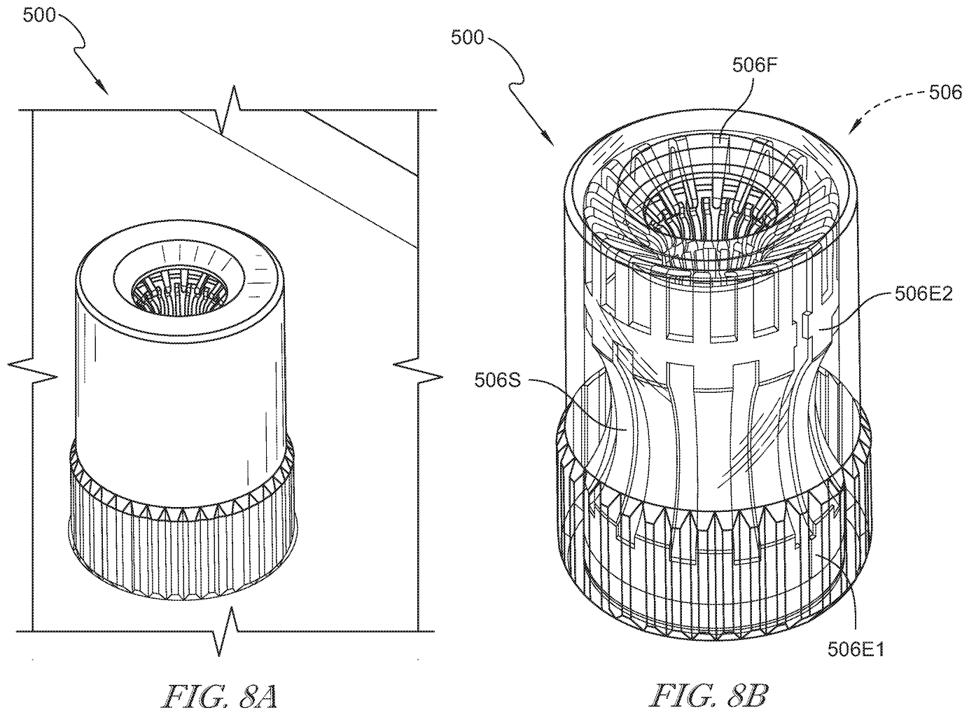

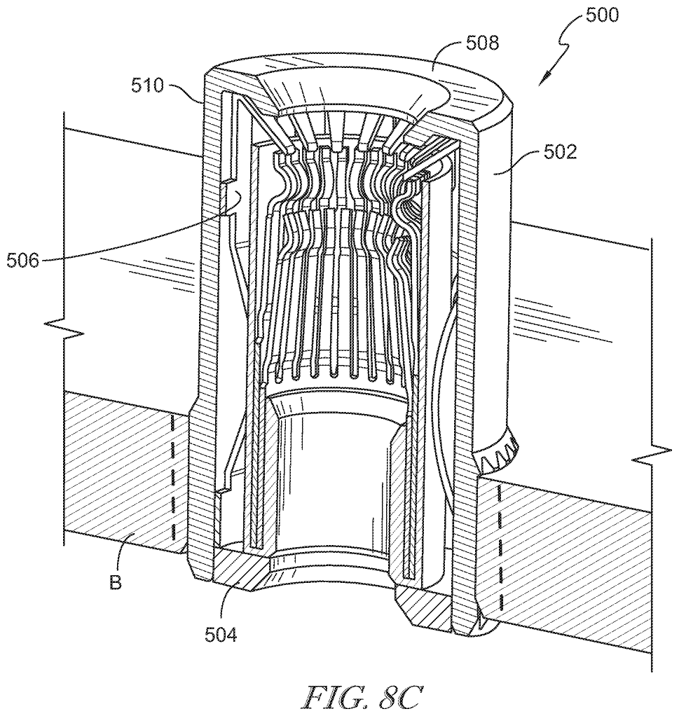

FIGS. 8A-8C show an illustrative fourth embodiment of an electrical connector 500. The electrical connector 500 is similar to the electrical connector 400, except that it includes an alternative biasing element 506 instead of the biasing element 406 of the electrical connector 500. As such, the description of the electrical connector 500 herein will be limited to a description of the alternative biasing element 506.

The biasing element 506 includes first and second annular and axially opposed end portions 506E1, 506E2 and an annular array of spring members 506S extending between the first end portion 506E1 and the second end portion 506E2. Each of the spring members 506S is curved inwardly from the end portions 506E1, 506E2, towards the axial centerline of the biasing element 506. As such, the biasing element 506 has an hourglass-like shape.

Each of the spring members 506S may be configured with one or more electrical contact areas 506C defined by an inner surface thereof. The contact areas 506C may be, but need not be, similar to the contact areas 106C of the first connector 100. The electrical contact areas 506C are configured to make electrical contact with the contact element 10. In some embodiments, each of the spring members 506 is configured with first and second electrical contact areas similar to the first and second electrical contact areas 106C1, 106C2 of the electrical connector 100. Each of the end portions 506E1, 506E2 is configured to make electrical contact with the base 102.

The biasing element 506 is configured so that the contact areas 506C of at least some of the spring members 506S remain in electrical contact with the contact element 10 regardless of the configuration of the contact element 10 with respect to the base 108. In an embodiment, the contact areas 506C of all of the spring members 506S remain in electrical contact with the regardless of the configuration of the contact element 10 with respect to the base 102. In an embodiment, the end portions 506E of the biasing element 506E remain in electrical contact with the contact element 10 regardless of the configuration of the contact element 10 with respect to the base 102.

The biasing element 506 further includes an array of contact fingers 506F extending axially outward from the second end portion 506E2. Each of the contact fingers 506F is bent radially inwardly between its free end and the second end portion 506E2 so that the contact finger 506F may contact the pin of the mating connector 200 when the pin is received with the contact element 10.

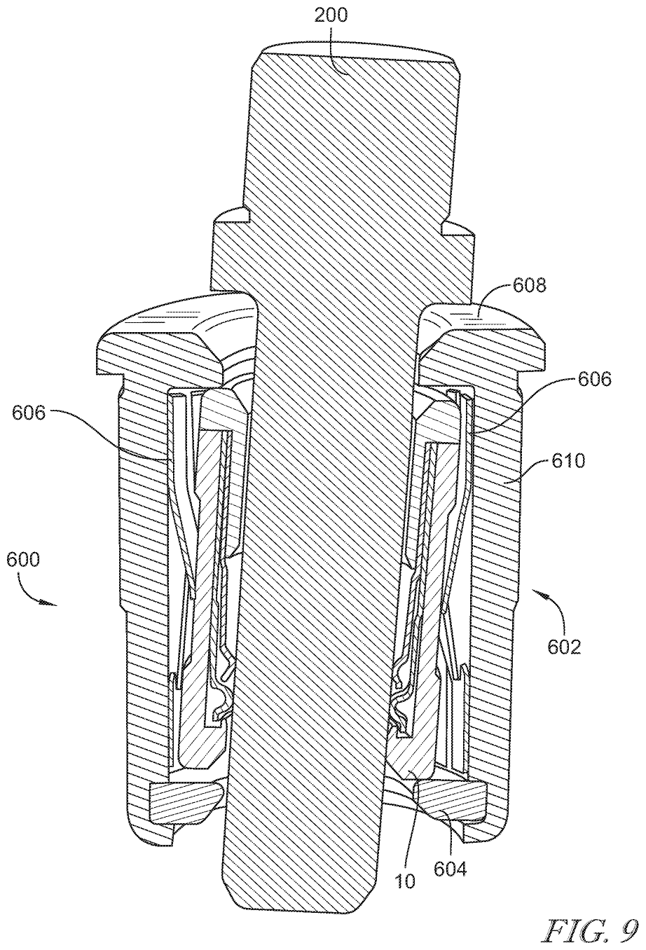

FIG. 9 shows an illustrative electrical connector element 600 having a base 602 similar to the base 402 of the electrical connector element 100 but having an in inverted positions with respect to the annular flange 102 and the retainer 104 of the electrical connector element 100. FIG. 9 shows the pin of the mating connector 200 inserted into the contact element 10 of the connector 600, with both the pin and the contact element 10 displaced at a substantial angle to an axis of the base 602 due to misalignment of the connector 600 and the mating connector 200.

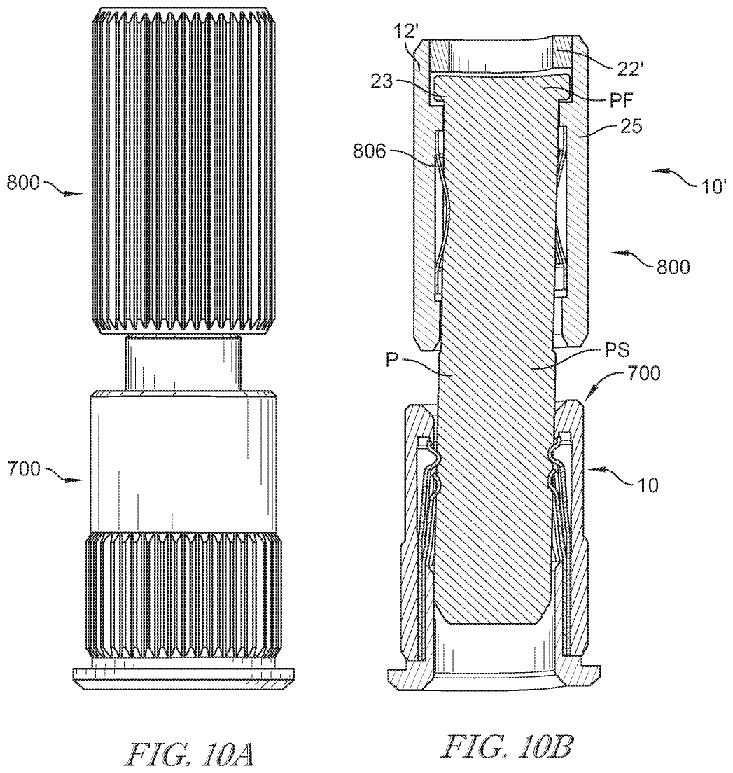

FIG. 10A shows another illustrative embodiment of an electrical connector 700 and an illustrative embodiment of a mating electrical connector 800 according to the present disclosure. FIG. 10B shows illustrative embodiments of contact elements 10, 10′ of the electrical connector 700 and the mating electrical connector 800, respectively. The mating contact element includes a pin P having a shaft PS and an annular flange PF extending radially outwardly from the shaft PF. The annular flange PF is captured within an annular housing 12′ by a retainer 22′ and an annular flange 25 extending radially inwardly into a cylindrical cavity defined by the housing 12′. A biasing element 806 similar to the biasing element 406 is disposed between the shaft PS of the pin P and the sidewall of the housing 12′. The housing 12′, the pin P, and the biasing element 806 are configured to allow pivoting and/or radially displacement of the pin P with respect to the housing 12′ in response to a displacing force, and to return the pin P to a neutral position with respect to the housing 12′ in the absence of the displacing force.

Dimensions shown in the drawings are illustrative and not limiting. Features of a given embodiment may be combined with features of other embodiments to the greatest extent possible.

The embodiments shown are illustrative and not limiting, with the invention being limited only by the appended claims.

1. (canceled)

2. An electrical connector for use with a separable mating electrical connector, the electrical connector comprising:
a mounting base configured for secure insertion into an aperture defined by a bus bar, the base defining a bore having an inner diameter, and the mounting base having a longitudinal axis;
a contact element disposed within the bore of the cylindrical base, the contact element having a first end and a second end, the contact element defining a bore configured to receive a pin of the separable mating electrical connector in continuous electrical engagement therewith, the contact element having an inner diameter and an outer diameter lesser than the inner diameter of the mounting base;
a biasing element disposed between the mounting base and the sidewall of the housing of the contact element, the biasing element configured to bias the contact element to a neutral position with respect to the mounting base; and
a retainer engaged with the base and configured to capture the cylindrical contact element and the biasing element to the mounting base;
wherein the contact element is electrically engaged with the mounting base, and
wherein the contact element is radially displaceable from the neutral position in response to a radial displacement force applied to the cylindrical contact element.

3. The electrical connector of claim 2 wherein the biasing element comprises first and second opposed and annular end portions and an annular array of spring members extending between the end portions, wherein each of the end portions is configured to make electrical contact with the mounting base.

4. The electrical connector of claim 3 wherein each of the spring members is bent radially inwardly from the end portions.

5. The electrical connector of claim 4 wherein each of the spring members defines an electrical contact point proximate a midpoint thereof.

6. The electrical connector of claim 4 wherein each of the spring members is bent radially outwardly proximate the midpoint thereof.

7. The electrical connector of claim 6 wherein each of the spring members defines a pair of electrical contact points proximate the midpoint thereof.

8. The electrical connector of claim 4 wherein the biasing element further comprises a plurality of contact fingers axially outwardly and radially inwardly from the second annular end portion, wherein a free ends of each of the plurality of contact fingers is configured to contact the pin of the mating connector when the pin is received within the contact element.

9. The electrical connector of claim 2 wherein the biasing element comprises first and second opposed and annular end portions, a first annular array of spring members extending radially inwardly and axially from the first end portion toward the second end portion, and a second array of spring members extending radially inwardly and axially from the second end portion toward the first end portion, wherein each of the end portions is configured to make electrical contact with the base and wherein each of the first and second spring members is configured to make electrical contact with the contact element.

10. The electrical connector of claim 9 wherein each of the first and second spring members comprises one or more electrical contact area defined by an inner surface thereof.

11. The electrical connector of claim 9 wherein each of the first and second spring members comprises a pair of electrical contact areas defined by an inner surface thereof.

12. The electrical connector of claim 2 wherein the separable mating connector comprises:
an annular housing defining a cylindrical cavity, the annular housing defining an annular flange extending radially inwardly into the cylindrical cavity;
a pin having a shaft and a flange extending radially outwardly from the shaft, the pin received within the housing;
a second retainer capturing the pin to the annular housing; and
a second biasing element disposed between the pin and the housing, the second biasing element configured to allow radial displacement of the pin with respect to the annular housing in response to a displacing force and to bias the pin to a neutral position with respect to the annular housing in the absence of the displacing force.

13. The electrical connector of claim 12 wherein the second biasing element comprises first and second annular and axially opposed end portions and an annular array of spring members extending between the first and second end portions.

14. The electrical connector of claim 13 wherein each of the spring members extends radially inwardly between the first and second end portions of the second biasing element.

15. The electrical connector of claim 13 wherein each of the spring members defines at least one electrical contact are between the first and second end portions of the second biasing element.

16. The electrical connector of claim 12 wherein the shaft of the pin is received within the annular flange.

17. The electrical connector of claim 16 wherein the flange of the pin is captured between the annular flange of the annular housing and the second retainer.

18. The electrical connector of claim 16 wherein the annular housing defines a second annular flange extending radially into the cylindrical cavity and wherein the second biasing element is disposed between the annular flange and the second annular flange.
